(19) United States
(12) Patent Application Publication
(10) Pub. No.: US 2012/0301816 A1
(43) Pub. Date: Nov. 29, 2012

(54) METHOD OF PREPARING CARBON THIN FILM, AND ELECTRONIC DEVICE AND ELECTROCHEMICAL DEVICES EACH INCLUDING THE CARBON THIN FILM

(75) Inventor: Tae-Woo LEE, Pohang-si (KR)

(73) Assignee: POSTECH ACADEMY-INDUSTRY FOUNDATION, Pohang-si (KR)

(21) Appl. No.: 13/478,097

(22) Filed: May 22, 2012

(30) Foreign Application Priority Data
May 27, 2011 (KR) 10- 2011-0050843

(51) Int. Cl. H01M 4/96; H01M 4/583; B32B 9/00; B05D 5/12; B05D 3/02; B82Y 30/00

(52) U.S. Cl. 429/523; 427/122; 429/231.8; 428/408; 977/734

(57) ABSTRACT

A method of preparing a carbon thin film, and an electronic device and an electrochemical device that include the carbon thin film.

### CROSS-REFERENCE TO RELATED PATENT APPLICATION

This application claims the benefit of Korean Patent Application No. 10-2011-0050843, filed on May 27, 2011, in the Korean Intellectual Property Office, the disclosure of which is incorporated herein in its entirety by reference.

### BACKGROUND OF THE INVENTION

1. Field of the Invention

The present invention relates to a method of preparing a carbon thin film, and an electronic device and an electrochemical device each including the carbon thin film.

2. Description of the Related Art

In general, carbonaceous materials may be classified into either diamond, graphite, graphene, or amorphous carbon. Diamond of these materials has no electrical conductivity due to sp³-bonded carbon atoms, while graphite has high electrical conductivity because of consisting of only sp² bonds. Including both sp^{a} bonds and sp² bonds, amorphous carbon may be lower in electrical conductivity than graphite. However, the electrical conductivity of graphite is mere similar to that of metal, and thus graphite has limited applications in the semiconductor industry. Also, graphene, which is known for the ability to solve this drawback of graphite, is currently receiving attention. Graphene is high in electrical conductivity and electron mobility, and thus, has a vast range of applications in the semiconductor industry and is being increasingly researched.

As methods of preparing conductive carbonaceous materials, pyrolysis of carbon fiber at a high temperature of 2000° C. or higher and separating of graphene from graphite lump using a scotch tape are available. However, the former fails to form carbonaceous materials in thin film form, and the latter may form only those in small flakes of a few microns in size. Furthermore, carbonaceous materials may be formed in thin film form by chemical vapor deposition (CVD), which needs use of explosive gas such as methane, propane, or the like, and a separate physical transfer process following etching of a catalyst metal, which likely damages the characteristics of the thin film. A method of chemically separating a carbonaceous thin film from graphite (for example, by dispersing small carbonaceous flakes in a solution) may be used. However, this method may not form a thin film having a satisfactory conductivity.

### SUMMARY OF THE INVENTION

The present invention provides a large-area, 2-dimensional carbon thin film preparation method that is economical, stable, safe, and environmentally friendly due to use of waste resources.

The present invention also provides an electronic device and an electrochemical device that each include the high conductivity carbon thin film.

According to an aspect of the present invention, there is provided a method of preparing a carbon thin film, the method including: forming a precursor film that includes at least one of coal tar and coal tar pitch on a substrate; forming at least one of a catalyst film between the substrate and the precursor film, and a protective film on the precursor film; and thermally treating the substrate to form the carbon thin film thereon.

The method may include forming the protective film on the precursor film, and the forming of the protective film on the precursor film may be performed after the formation of the precursor film.

Three method may include forming the catalyst film between the substrate and the precursor film, and the forming of the catalyst film on the substrate may be performed before the formation of the precursor film.

The method may include forming the protective film on the precursor film and forming the catalyst film between the substrate and the precursor film, and the forming of the catalyst film on the substrate may be performed before the formation of the precursor film, and the forming of the protective film on the precursor film may be performed after the formation of the precursor film.

The substrate may include silicon, silicon oxide, silicon nitride, metal foil, metal oxide, highly ordered pyrolytic graphite (HOPG), hexagonal boron nitride (h-BN), a c-plane sapphire wafer, zinc sulfide (ZnS), a polymer substrate, or a combination of at least two of these materials. The substrate may be any substrate having a crystalline structure, not limited to the above. In some embodiments, when the substrate is a Ni foil, a Cu foil, a Pd foil, a MgO substrate, a ZnS substrate, a c-plane sapphire substrate, or a h-BN substrate, the carton thin film may be obtained with exclusion of the catalyst film or the protective film.

The protective film may include at least one material of a metal, a inorganic oxide (e.g. metal oxide, silicone oxide), and a inorganic nitride.

The protective film may include metals such as copper (Cu), nickel (Ni), palladium (Pd), gold (Au), silver (Ag), aluminum (Al), and molybdenum (Mo), metal oxides such as copper oxide, nickel oxide, palladium oxide, aluminum oxide, and molybdenum oxide, other inorganic oxides such as silicon oxide and germanium oxide, inorganic nitrides such as silicon nitride, boron nitride, lithium nitride (Li₃N), copper nitride (Cu₃N), Mg₃N₂, Be₃N₂, Ca₃N₂, Sr₃N₂, and Ba₃N₂, or a combination of at least two of these materials above.

The protective film may have a thickness from about 2 nm to about 2000 nm.

The catalyst film may include nickel (Ni), cobalt (Co), iron (Fe), gold (Au), palladium (Pd), aluminum (Al), chromium (Cr), copper (Cu), magnesium (Mg), molybdenum (Mo), rhodium (Rh), silicon (Si), tantalum (Ta), titanium (Ti), tungsten (W), uranium (Ur), vanadium (V), zirconium (Zr), or a combination of at least two of these materials.

The catalyst film may have a thickness from about 100 nm to about 1000 nm.

The thermal treatment may be performed under the condition where at least one of the coal tar and the coal tar pitch in the precursor film is carbonized. The thermal treatment may be performed in an inert atmosphere or in a vacuum at a temperature from a temperature higher than or equal to thermal degradation temperature of at least one of the coal tar and the coal tar pitch in the precursor film to about 2000° C. or less for a duration from about 1 second to about 5 days.

At least part of the protective film may remain on the carbon thin film after the forming of the carbon thin film on the substrate, and the method may further include removing the protective film remaining on the carbon thin film.

The method may further comprise at least one of patterning the precursor film and at least one of the catalyst film and the protective film in a predetermined pattern before the thermal treatment, and patterning the carbon thin film in a predetermined pattern after the thermal treatment.

The carbon thin film may be selected from the group consisting of a graphite sheet, a graphene sheet, and an amorphous carbon sheet.

According to an aspect of the present invention, there is provided an electronic device including a carbon thin film prepared by the above-described method. The carbon thin film may be applicable as an electrode or wiring of various kinds of electronic devices, or an active layer (for example, an active layer of a semiconductor device).

The electronic device is an inorganic light-emitting diode, an organic light-emitting diode, an inorganic solar cell, an organic photovoltaic diode (OPV), an inorganic thin film transistor, a memory, an electrochemical/bio sensor, an RF device, a rectifier, a complementary metal oxide semiconductor (CMOS) device, or an organic thin film transistor (OTFT).

According to an aspect of the present invention, there is provided an electrochemical device including a carbon thin film prepared by the above-described method.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view for describing a method of preparing a carbon thin film, according to an embodiment of the present invention;

FIG. 2 is a cross-sectional view for describing a method of preparing a carbon thin film, according to another embodiment of the present invention;

FIG. 3 is a cross-sectional view for describing a method of preparing a carbon thin film, according to another embodiment of the present invention;

FIG. 4 is a schematic cross-sectional view of an organic light emitting diode (OLED) including the carbon thin film, according to an embodiment of the present invention;

FIG. 5 is a schematic cross-sectional view of an organic photovoltaic diode (OPV) including the carbon thin film, according to an embodiment of the present invention;

FIG. 6 is a schematic cross-sectional view of an organic thin film transistor (OTFT) including the carbon thin film, according to an embodiment of the present invention;

FIG. 7 illustrates Raman spectra of a carbon thin film according to Example 1; and

FIG. 8 is Raman mapping images of the carbon thin film according to Example 1.

### DETAILED DESCRIPTION OF THE INVENTION

As used herein, the term “and/or” includes any and all combinations of one or more of the associated listed. Expressions such as “at least one of,” when preceding a list of elements, modify the entire list of elements and do not modify the individual elements of the list.

According to an embodiment of the present invention, a method of preparing a carbon thin film includes: forming a precursor film on a substrate, the precursor film including at least one of coal tar and coal tar pitch; forming at least one of a catalyst film between the substrate and the precursor film, and a protective film on the precursor film; and thermally treating the substrate to form the carbon thin film on the substrate.

As used herein, the meaning of that “the precursor film is formed on the substrate” includes both that the precursor film is formed directly on the substrate, and that the precursor film is formed on the substrate with an intervening film (such as a catalyst film) therebetween.

Since the protective film is formed on a surface of the precursor film (opposite to a surface facing the substrate), forming the protective layer may be performed after the precursor layer is formed, when the method comprises the forming the protecting layer on the precursor film.

Since the catalyst film is between the substrate and the precursor film, forming the catalyst layer may be performed before the formation of the precursor layer, when the method comprises the forming the catalyst layer between the substrate and the precursor film.

The present disclosure will now be described more fully with reference to the accompanying drawings, in which exemplary embodiments of the present disclosure are shown.

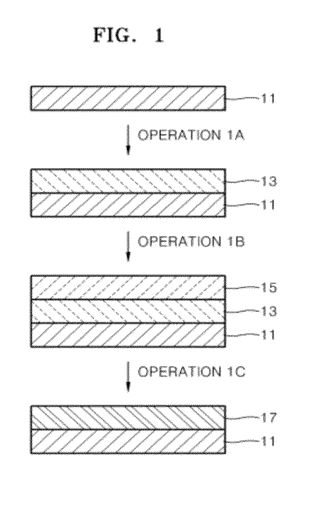

FIG. 1 is a cross-sectional view for describing a method of preparing a carbon thin film, according to an embodiment of the present invention.

Referring to FIG. 1, in the current method of forming a carbon thin film, first, a substrate 11 is prepared. The substrate 11 may include a material that does not substantially react with a material of a precursor film 13 that is to be formed on the substrate 11, and that is not liable to deform or degrade on exposure to high temperatures.

The substrate 11 may be a substrate that is widely used in semiconductor manufacturing processes, and in some embodiments, may include any of a variety of materials. For example, the substrate 11 may include silicon, silicon oxide, metal foil (such as copper foil, aluminum foil, nickel foil, palladium foil, stainless steel, and the like), highly ordered pyrolytic graphite (HOPG), hexagonal boron nitride (h-BN), c-plane sapphire wafer, zinc sulfide (ZnS), a polymer substrate, or a combination of at least two thereof. The metal foil may be formed using a material having a high-melting point and capable of forming a carbon thin film but that does not serve as a catalyst in forming the carbon thin film formation catalyst, such as aluminum foil, or may be formed using a material that serves as a catalyst in forming a carbon thin film, such as copper foil, nickel foil, and the like. Non-limiting examples of the metal oxide are aluminum oxide, molybdenum oxide, magnesium oxide (MgO), and indium tin oxide. Non-limiting examples of the polymer substrate are kapton foil, polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), and cellulose acetate propionate (CAP).

When a metal foil including a material that possesses a catalytic function in forming a carbon thin film, such as Cu, Ni, Pd, or the like, is used as the substrate 11 in order to facilitate carbonization of the precursor film 13, the forming of a catalyst film on the substrate may be omitted.

When HOPG, h-BN, c-plane sapphire wafer, or ZnS is chosen as a material of the substrate 11, the carbon thin film may be formed without forming the catalyst film on the substrate 11.

The substrate 11 may have a single layer structure consisting of at least one materials, and in another embodiment, may have a multi-layer structure including a stack of layers, each consisting of at least two kinds of materials. For example, the substrate 11 may have a double-layer structure including a silicon layer and a silicon oxide layer.

Once the substrate 11 is prepared, the precursor film 13 that includes at least one of coal tar and coal tar pitch is formed on the substrate 11 (Operation 1A). Operation 1A may be performed using a coating process.

Coal tar is a high-viscous liquid in dark brown or black produced as a byproduct from dry distillation of coal at a temperature from about 900° C. to about 1200° C., which may have various, complex compositions.

Coal tar pitch is a generic term meaning residues from distillation or heat treatment of coal tar.

The components of coal tar may be mostly any one of hydrocarbons, acids, and bases. The hydrocarbons may include aromatic hydrocarbons, for example, benzene, toluene, xylene, acenaphthene), fluorene, phenanthrene, anthracene, pyrene, and chrysene, but are not limited thereto. The acids may include phenols, such as phenol, cresol, xylenol, and naphthol. The bases may include aniline, pyridine, pyrroline, rutidine, quinoline, isoquinoline, acridine, and the like. The other component of the coal tar may be or diphenylene oxide, non-basic nitrogen compounds, such as carbazole, or organic sulfur compounds, such as mercaptan or thiophenol. Coal tar may be separated by distillation into light oil up to about 180° C., medium oil up to about 230° C., heavy oil up to about 270° C., anthracene oil up to about 350° C., and the rest as coal tar pitch.

The coal tar pitch may have a specific gravity of from about 1.2 to about 1.4, and a melting point of from about 40° C. to about 90° C. The coal tar pitch may be classified into soft (liquid) pitch, medium pitch, or hard (solid) pitch depending on a distillation degree of coal tar.

During the distillation of coal tar the components of the coal tar in the complex composition described above undergo various reactions, which may lead to coal tar pitch with a complex composition. For example, the coal tar pitch may be a mixture of various aromatic hydrocarbon compounds and heterocyclic compounds.

Non-limiting examples of materials included in the coal tar pitch are pentalene, indene, naphthalene, azulene, heptalene, indacene, acenaphthylene, acenaphthene, fluorene, phenalene, phenanthrene, anthracene, fluoranthene, triphenylene, pyrene, benzoanthracene, chrysene, naphthacene, picene, perylene, pentaphene, hexacene, benzofluoranthene, benzopyrene, indenopyrene, dibenzanthracene, benzoperylene, quinoline, furan, indole, chromene, benzothiophene, benzoquinoline, xathene, pyrrole, thiophene, imidazole, pyrazole, isothiazole, isobenzofuran, isoxazole, pyran, pyridine, pyrazine, pyrimidine, pyridazine, phthalazine, quinoxaline, quinazoline, indazole, phenazine, phenoxazine, acridine; a fused cyclic structure from at least two of these materials; a cyclic structure with at least two linkers (for example, a single bond, a C₁-C₂₀ alkylene group, or the like) of these materials; a hydrogen saturated derivative of these materials; and/or a derivative of these materials of which at least one hydrogen is substituted with a halogen atom, a nitro group, a carboxylic acid, a salt thereof, a C₁-C₂₀ alkyl group, a C₂-C₂₀ alkylene group, or a C₁-C₂₀ alkoxy group.

In some embodiments, the coal tar pitch may have any of the materials represented by the following formulae, but is not limited thereto:

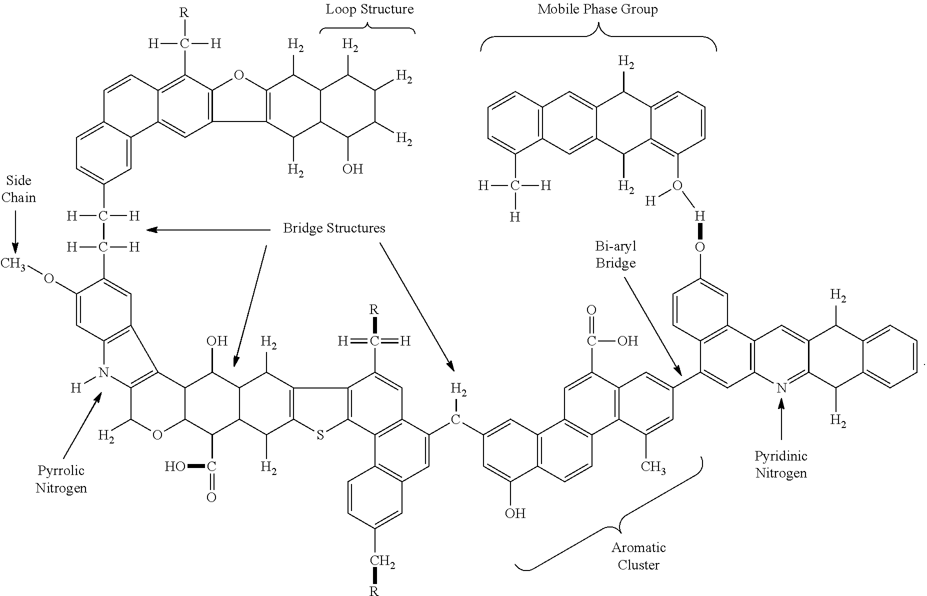

The coal tar pitch may be any commercially available product.

The coal tar and/or coal tar pitch included in the precursor film 13 may be not limited in specific gravity and softening point ranges, but may be selected from among materials that are able to form a thin film by being dissolved in a solvent.

Operation 1A may include providing a mixture that includes at least one of coal tar and coal tar pitch on the substrate 11. The mixture may further include at least one material selected from among a solvent, an acid catalyst, a metal filler, a ceramic filler, and nanoparticles, if desired.

The solvent may be a material that may offer the mixture an appropriate viscosity and flowability and that may be miscible but not substantially chemically react with coal tart and coal tar pitch. Non-limiting examples of the solvent are tetrahydrofuran, quinoline, hexane, benzene, toluene, xylene, chlorobenzene, dichlorobenzene, trichlorobenzene, cyclohexanone, chloroform, and dichloroethane.

The mixture may be provided onto the substrate 11 via a known coating process. Non-limiting examples of the coating process are spin coating, inkjet printing, nozzle printing, dip coating, electrophoresis, tape casting, screen printing, doctor blade coating, gravure printing, gravure offset printing, a Langmuir-Blodgett (LB) method, or a layer-by-layer self-assembly method. In an embodiment, the coating process may use a spin coating method.

Concentration adjustment of the coal tar and/or coal tar pitch in the mixture may control the amount of the coal tar and/or coal tar pitch per unit volume of the precursor film 13, and consequently the thickness of the precursor film 13. As a result, the thickness of a carbon thin film 17 (see FIG. 1) may be controlled. Therefore, in the carbon thin film preparation method, the thickness of the carbon thin film 17 may be controlled by the concentration adjustment of the coal tar and/or coal tar pitch in the mixture.

After providing the mixture onto the substrate 11, a soft baking process for removing the solvent from the mixture may be optionally performed to form the precursor film 13 on the substrate 11.

The temperature and time ranges of the soft backing process may vary depending on the kind of chosen solvent, the concentration of coal tar and/or coal tar pitch in the mixture, and the like.

The thickness of the precursor film 13 may be controlled by concentration adjustment of the coal tar and/or coal tar pitch in the mixture. The thickness of the precursor film 13 may be from about 2 nm to about 50 μm. When the thickness of the precursor film 13 is within these ranges, a carbon thin film may be formed to have a thickness greater than or equal to a graphene monolayer, and the precursor film 13 may be formed with uniform quality.

For example, the thickness of the precursor film 13 may be from about 1 nm to about 50 μm. When the thickness of the precursor film 13 is within this range, the carbon thin film 17 may have a thickness from about 0.34 nm (that is equivalent to that of a graphene monolayer) to about 50 nm, and may have a high transmittance with respect to a visible wavelength range of light, thus applicable as a transparent electrode in various kinds of displays. In an embodiment where the thickness of the precursor film 13 is adjusted to be about 50 μm or greater, the carbon thin film 17 may also be applicable as a wire electrode.

Next, a protective film 15 is formed on the precursor film 13 (Operation 1B). The protective film 15 may prevent thermal loss of the coal and/or coal tar pitch in the precursor film 13 during a thermal treatment where the precursor film 13 is converted into the carbon thin film 17.

The protective film 15 may include metal, inorganic oxide (e.g. metal oxide, silicon oxide), inorganic nitride or a combination of at least two thereof. For example, the protective film 15 may include copper (Cu), nickel (Ni), palladium (Pd), gold (Au), silver (Ag), aluminum (Al), molybdenum (Mo), copper oxide, nickel oxide, palladium oxide, aluminum oxide, molybdenum oxide, silicon oxide and germanium oxide, silicon nitride, boron nitride, lithium nitride (Li₃N), copper nitride (Cu₃N), Mg₃N₂, Be₃N₂, Ca₃N₂, Sr₃N₂, and Ba₃N₂ or a combination of at least two of these materials, but is not limited thereto.

The protective film 15 may have a thickness from about 2 nm to about 2000 nm, and in some embodiments, may have a thickness of about 300 nm to about 600 nm. When the thickness of the protective layer 15 is within these ranges, the carbon thin film 17 with uniform quality may be formed.

The protective film 15 may be formed using a general method of forming a metal film and/or metal oxide film, for example, using vapor deposition.

After operation 1B, a thermal treatment is performed to convert the precursor film 13 into the carbon thin film 17 (Operation 1C).

The thermal treatment may be performed under the condition where at least one of the coal tar and the coal tar pitch in the precursor film 13 may be carbonized.

To this end, the thermal treatment may be performed in an inert atmosphere (for example, nitrogen atmosphere, argon atmosphere, or the like) or in a vacuum. Optionally, to facilitate carbonization or induce defects to the carbon thin film 17 for modification of the work function of the carbon thin film 17, an impurity gas such as hydrogen, methane, or CF₄ gas may be injected during the thermal treatment.

In some embodiments the thermal treatment may be performed at a temperature from a temperature higher than or equal to a thermal degradation temperature of the coal tar and/or the coal tar pitch in the precursor film 13 to about 2000° C. or less (for example, at a temperature from 600° C. to about 1500° C.) for a duration from about 1 second to about 5 days (for example, from 1 second to about 20 hours). The thermal treatment condition, temperature, and duration may be chosen depending on the amount of the coal tar and/or coal tar pitch included in the precursor film 13.

During the thermal treatment operation 1C, with the carbonization of the precursor film 13, the carbon thin film 17 is formed. A domain with a graphene structure may also be formed in the carbon thin film 17.

By adjustment of the temperature of the thermal treatment operation 1C to a temperature higher than or equal to a melting temperature of the material in the protective film 15, the protective film 15 may be removed at the same time as the formation of the carbon thin film 17.

However, if the thermal treatment condition of Operation 1C is not satisfactory to remove the protective film 15, although not shown in FIG. 1, more than part of the protective film 15 may remain on the carbon thin film 17. Accordingly, the carbon thin film preparation method may further include removing the protective film 15 that remains on the carbon thin film 17. The protective film 15 remaining on the carbon thin film 17 may be removed using a known method of removing a metal film and/or metal oxide film. In an embodiment, the protective film 15 remaining on the carbon thin film 17 may be removed by washing the surface of the carbon thin film 17 with an etchant for removing metal or metal oxide.

Since based on coating and thermal treatment processes, the carbon thin film preparation method may be economical and stable to form a large-area, 2-dimensional carbon thin film.

By concentration adjustment of the coal tar and/or coal tar pitch in the mixture for forming the precursor film 13, the thickness of the carbon thin film 17 may be easily controlled, which facilitates formation of the carbon thin film 17 in various structures and sizes.

The carbon thin film preparation method uses coal tar and/or coal tar pitch, which are byproducts in the steel and petrochemical industries, as a starter material for forming the carbon thin film 17, and thus is environmentally friendly in view of recycling of resource. The carbon thin film preparation method also ensures safety because it does not use explosive gas such as CH₄ gas, C₂H₄ gas, or the like.

To facilitate patterning of the carbon thin film 17, the protective film 15 and the precursor film 13 may be patterned before Operation 1C, or the carbon thin film 17 may be patterned after Operation 1C and before separation of the carbon thin film 17 from the substrate 11. Various kinds of device structures may be formed directly on the patterned carbon thin film 17, and thus the carbon thin film 17 may be readily applicable as an electrode or wiring in any of a various patterns.

The patterning method may be at least one selected from photolithography, soft lithography, electron beam lithography, nanoimprint lithography, mold-assisted lithography, step-and-flash imprint lithography, dip pen lithography, and microcontact printing, and inkjet printing. Patterning using a photosensitiser and a mask, and/or patterning using oxygen plasma or reactive ion etching (RIE) may be used.

The carbon thin film 17 may be a graphite sheet, a graphene sheet (or film), or an amorphous carbon film. The graphene sheet may be a graphene monolayer having a thickness of about 0.34 nm, a few layer-graphene being a stack of two to ten graphene monolayers, or a multilayers-graphene being stack of multiple graphene monolayers, i.e., more than 2 to 10 graphene monolayers. For example, the carbon thin film 17 may be a graphene sheet. In an embodiment the carbon thin film 17 may include the few graphene monolayers, but is not limited thereto. The carbon thin film 17 may have a transmittance of about 50% or greater with respect to a visible wavelength range of light. The carbon thin film 17 may have high conductivity. For example, the carbon thin film 17 may have a conductivity of about 10 S/cm or greater.

In the embodiment of FIG. 1 the carbon thin film preparation method involves forming the precursor film 13 (Operation 1A) and forming the protective film 15 on the precursor film 15 (Operation 1B).

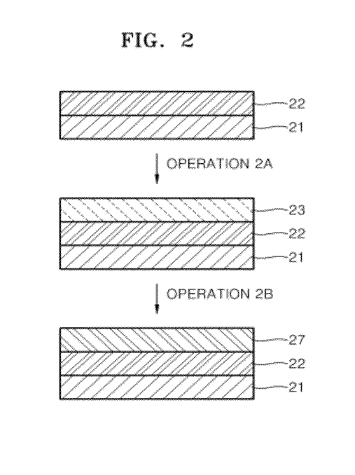

FIG. 2 illustrates a carbon thin film preparation method according to another embodiment of the present invention. The method of FIG. 2 is substantially the same as the carbon thin film preparation method described with reference to FIG. 1, except that after formation of a catalyst film 22 on a substrate 21, a precursor film 23 is formed on the catalyst film 22, and a carbon thin film 27 is formed without forming the protective film 15 of FIG. 1. With regard to the method of FIG. 2, the above-detailed descriptions of the substrate 11, the precursor film 13, the carbon thin film 17, and Operations 1A and 1C of FIG. 1 may be referred to for those of the substrate 21, the precursor film 23, the carbon thin film 27, and Operations 2A and 2B of FIG. 2, respectively.

The catalyst film 22 serves as a catalyst in forming a graphene structure during the formation of the carbon thin film 27 by thermal treatment, thereby enlarging a graphene structured domain in the carbon thin film 27.

The catalyst film 22 may include nickel (Ni), cobalt (Co), iron (Fe), gold (Au), palladium (Pd), aluminum (Al), chromium (Cr), copper (Cu), magnesium (Mg), molybdenum (Mo), rhodium (Rh), silicon (Si), tantalum (Ta), titanium (Ti), tungsten (W), uranium (Ur), vanadium (V), zirconium (Zr), or a combination of at least two of these materials.

The catalyst layer 22 may have a thickness from about 100 nm to about 1,000 nm, and in some embodiments, may have a thickness from about 400 nm to about 600 nm. When the thickness of the catalyst layer 22 is within these ranges, the carbon thin film 27 having improved crystalline properties may be formed.

In the embodiment of FIG. 2 the carbon thin film preparation method involves forming the catalyst film 22 on the substrate 21 before the forming of the precursor layer 23 (Operation 2A).

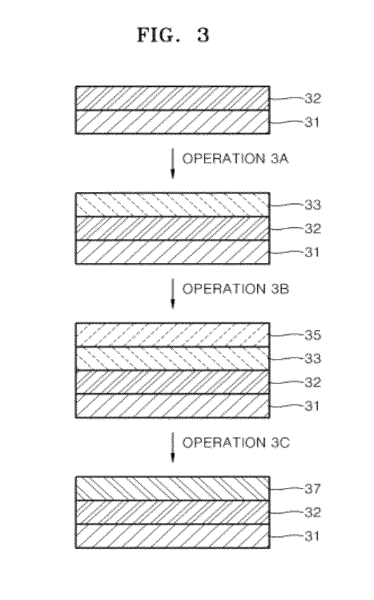

FIG. 3 illustrates a carbon thin film preparation method according to another embodiment of the present invention. The method of FIG. 3 is substantially the same as the carbon thin film preparation method described with reference to FIG. 1, except that after further forming a catalyst film 32 on a substrate 31, a precursor film 33 is formed on the catalyst film 32. With regard to FIG. 3, the above-detailed descriptions of the substrate 11, the precursor film 13, the protective film 15, the carbon thin film 17, and Operations 1A, 1B, and 1C may be referred to for those of the substrate 31, the precursor film 33, the protective film 35, the carbon thin film 37, and Operations 3A, 3B, and 3C of FIG. 3.

The carbon thin film (17, 27, 37) may be used in various kinds of layers that need to be conductive. For example, the carbon thin film (17, 27, 37) may be applicable as an electrode, wiring, or a channel layer of various types of electronic devices and electrochemical devices. Non-limiting examples of electronic devices to which the carbon thin film is applicable are an inorganic light-emitting diode, an organic light-emitting diode, an inorganic solar cell, an organic photovoltaic diode (OPV), an inorganic thin film transistor, a memory, an electrochemical/bio sensor, an RF device, a rectifier, a complementary metal oxide semiconductor (CMOS) device, and an organic thin film transistor (OTFT). Non-limiting examples of electrochemical devices to which the carbon thin film is applicable are a lithium battery and a fuel cell.

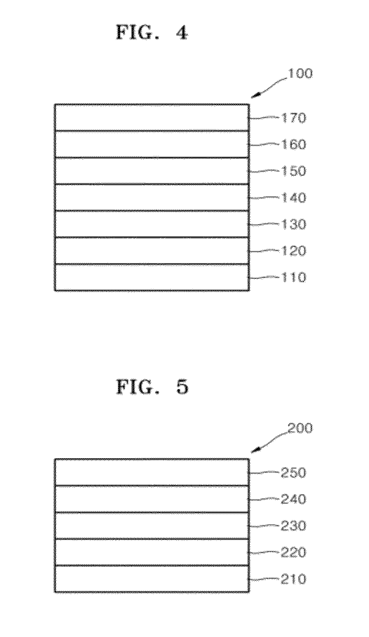

FIG. 4 is a schematic view of an organic light-emitting diode (OLED) 100 according to an embodiment of the present invention. Referring to FIG. 4, the OLED 100 may include a first electrode 110, a hole injection layer (HIL) 120, a hole transport layer (HTL) 130, an emission layer (EML) 140, an electron transport layer (ETL) 150, an electron injection layer (EIL) 160, and a second electrode 170. When a voltage is applied across the first electrode 110 and the second electrode 170 of the OLED 100, holes injected from the first electrode 110 migrate to the EML 140 through the HIL 120 and the HTL 130, while electrons injected from the second electrode 170 migrate to the EML 140 through the ETL 150 and the EIL 160. The holes and electrons (carriers) recombine in the EML 140 to generate excitons. When the excitons drop from an excited state to a ground state, light is emitted.

The first electrode 110 may be a carbon thin film prepared by any of the methods described above.

The HIL 120 may be formed using any known method, such as a vacuum deposition method, a spin coating method, a casting method, or an LB deposition method. If the HIL 120 is formed using vacuum deposition, the deposition conditions may vary according to the material that is used to form the HIL 120, and the structure and thermal characteristics of the HIL 120 to be formed. For example, the deposition conditions may include a deposition temperature of about 100° C. to about 500° C., a degree of vacuum of about 10⁻¹⁰ to about 10⁻³ torr, and a deposition rate of about 0.01 to 100 Å/sec. The HIL 120 is formed using the spin coating method, coating conditions may differ according to the target material, the target layer structure, and thermal characteristics. In this regard, in general, the coating rate may be about 2000 rpm to about 5000 rpm, and the thermal treatment temperature may be from about 80° C. to about 200° C. at which a solvent used is removed after the coating.

The HIL 120 may be formed of any hole-injecting material that is known in the art. Nonlimiting examples of suitable hole-injecting materials include a phthalocyanine compound such as copper phthalocyanine, 4,4′,4″-tris (3-methylphenylphenylamino)triphenylamine (m-MTDATA; See the formula below), TDATA (See the formula below), 2T-NATA (See the formula below), polyaniline/dodecylbenzenesulfonic acid (Pani/DBSA), poly(3,4-ethylenedioxythiophene)/poly(4-styrenesulfonate) (PEDOT/PSS), polyaniline/camphor sulfonic acid (Pani/CSA), and polyaniline/poly(4-styrenesulfonate (PANI/PSS).

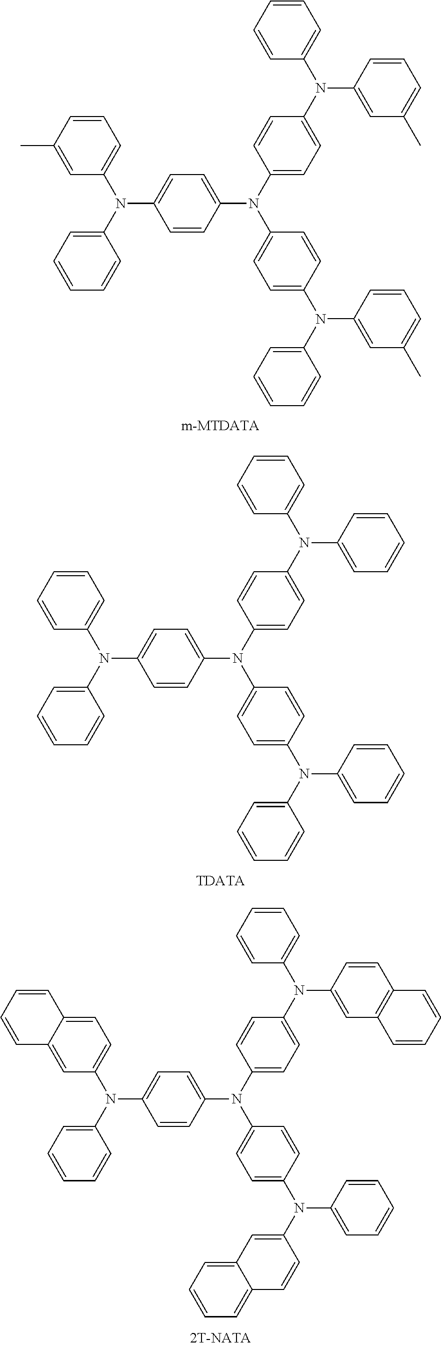

The thickness of the HIL 120 may be from about 100 Å to about 10,000 Å, and in some embodiments, may be from about 100 Å to about 1,000 Å. When the thickness of the HIL 120 is within these ranges, the HIL 120 may have satisfactory hole injection characteristics without an increase in driving voltage.

The HTL 130 may be formed using a method selected from various known methods such as a vacuum deposition method, a spin coating method, a cast method, or an LB deposition method. In this regard, deposition conditions and coating conditions may differ according to the target material, the target layer structure, and thermal characteristics, but may be the same or similar to those described with reference to the HIL 120.

The HTL 130 may be formed using any known hole transporting material. Examples of the hole transporting material include: amine derivatives having an aromatic condensed ring, such as N,N′-di(1-naphthyl)-N,N′-diphenylbenzidine (NPB) and N,N′-bis(3-methylphenyl)-N,N′-diphenyl-[1,1-biphenyl]-4,4′-diamine (TPD), and triphenylamine-based materials, such as 4,4′,4″-tris(N-carbazolyl)triphenylamine (TCTA). TCTA of these materials may not only transport holes but also inhibit excitons from being diffused from the EML 140.

The thickness of the HTL 130 may be from about 50 Å to about 1,000 Å, and in some embodiments, may be from about 100 Å to about 600 Å. When the thickness of the HTL is within these ranges, the HTL may have satisfactory hole transport characteristics without a substantial increase in driving voltage.

The EML 140 may be formed using any known method, such as a vacuum deposition method, a spin coating method, a casting method, or an LB deposition method. In this regard, deposition conditions and coating conditions may differ according to the target material, the target layer structure, and thermal characteristics, but may be the same or similar to those described with reference to the HIL 120.

The EML 140 may be formed using only a single light-emitting material. In some embodiments the EML 140 may include a host and a dopant.

Example of the host include Alq₃, 4,4′-N,N′-dicarbazole-biphenyl (CBP), 9,10-di(naphthalene-2-yl)anthracene (ADN), TCTA, 1,3,5-tris(N-phenylbenzimidazole-2-yl)benzene (TPBI), 3-tert-butyl-9,10-di-2-naphthylanthracene (TBADN), E3 (see the formula below), and BeBq₂ (see the formula below), but are not limited thereto.

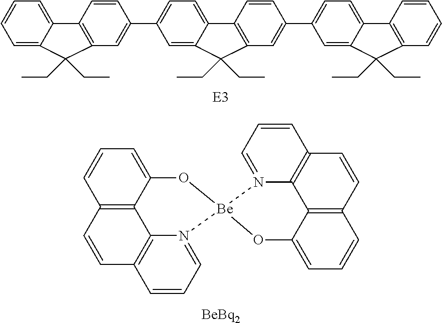

Examples of known red dopants include, but are not limited to, PtOEP, Ir(piq)₃, and Btp₂Ir(acac).

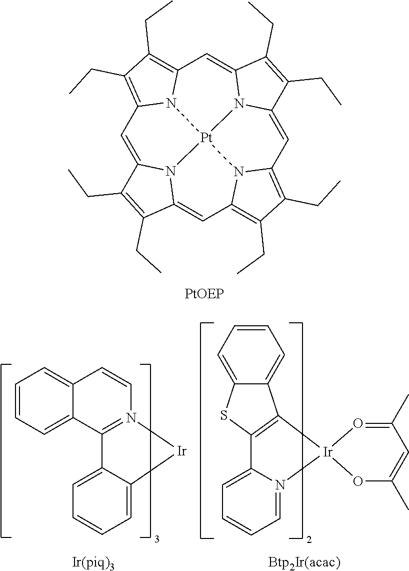

Examples of known green dopants include, but are not limited to, Ir(ppy)₃ (where “ppy” denotes phenylpyridine), Ir(ppy)₂(acac), Ir(mpyp)₃, and C545T.

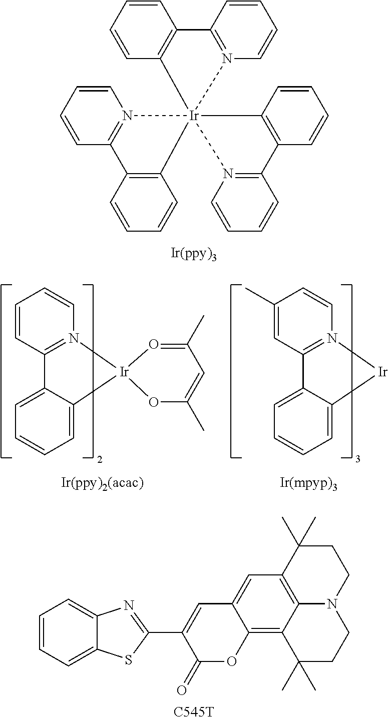

Examples of known blue dopants include F₂Irpic, (F₂ ppy)₂Ir(tmd), Ir(dfppz)₃, ter-fluorene, 4,4′-bis[4-(di-p-tolylamino)styryl]biphenyl (DPAVBi), or 2,5,8,11-tetra-tert-butyl perylene (TBP), but is not limited thereto.

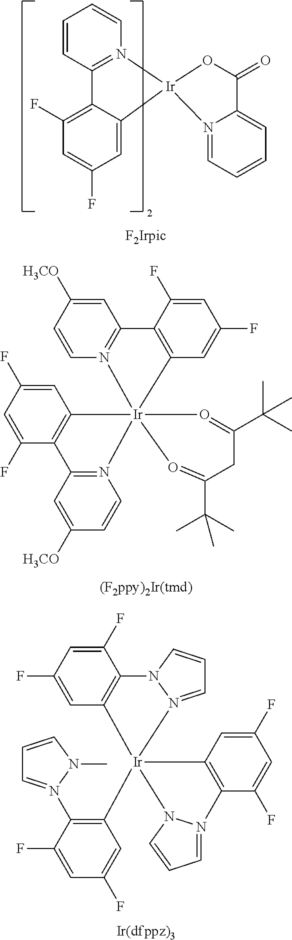

The thickness of the EML 140 may be from about 100 Å to about 1,000 Å, and in some embodiments, from about 100 Å to about 600 Å. When the thickness of the EML 140 is within these ranges, the EML 140 may have satisfactory light-emitting properties without a substantial increase in driving voltage.

A hole blocking layer (HBL) (not shown in FIG. 4) may be further formed on the EML 140. For example, when the EML 140 includes a phosphorescent compound, the HBL may block triplet excitons or holes from diffusing into, for example, a cathode. The HBL may be formed using any known method, such as a vacuum deposition method, a spin coating method, a casting method, or an LB deposition method. In this regard, deposition conditions and coating conditions may differ according to the target material, the target layer structure, and thermal characteristics, but may be the same or similar to those described in conjunction with the HIL 120.

The HBL may be formed using any known hole blocking material. Examples of the hole blocking material include an oxadiazole derivative, a triazole derivative, and a phenanthroline derivative.

The thickness of the HBL may be from about 50 Å to 1,000 Å, and in some embodiments, may be from about 100 Å to about 400 Å. When the thickness of the HBL is within these ranges, the HIL may have satisfactory hole blocking characteristics without a substantial increase in driving voltage.

The ETL 150 may be formed using any known method such as a vacuum deposition method, a spin coating method, a casting method, or an LB deposition method. The ETL 150 may be formed on the EML 140 or the HBL. In this regard, deposition conditions and coating conditions may differ according to the target material, the target layer structure, and thermal characteristics, but may be the same or similar to those described in conjunction with the HIL 120.

The ETL 150 may be formed using any known electron transporting material. Examples of the electron transporting material include tris(8-quinolinolate)aluminum (Alq₃), TAZ, 4,7-diphenyl-1,10-phenanthroline (Bphen), BCP, BeBq₂, and BAIq:

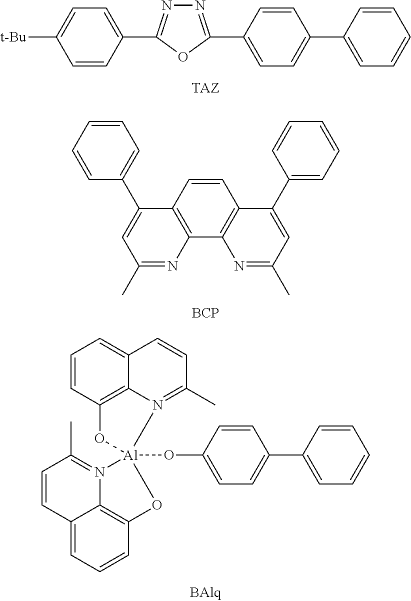

The ETL 150 may have a thickness of about 100 Å to about 1,000 Å, and in some embodiments, may have a thickness of about 200 Å to about 500 Å. When the thickness of the ETL 150 is within these ranges, the ETL 150 may have satisfactory electron transport properties without a substantial increase in a driving voltage.

The EIL 160 may be formed on the ETL 150. The EIL 160 may be formed using any known electron injection material such as LiF, NaCl, CsF, Li₂O, BaO, or BaF₂. Deposition conditions for forming the EIL 160 may vary according to a material that is used to form the EIL 160, but may be similar to those described in conjunction with the HIL 120.

The thickness of the EIL 160 may be from about 1 Å to about 100 Å, and in some embodiments, may be from about 5 Å to about 50 Å. When the thickness of the EIL 160 is within these ranges, the EIL 160 may have satisfactory electron injection ability without a substantial increase in driving voltage.

The second electrode 170 may act as a cathode (electron injection electrode), and may be formed using a metal having a relatively low work function, an alloy having a relatively low work function, an electrically conductive compound having a relatively low work function, and any mixtures thereof. Non-limiting examples of these materials include lithium (Li), magnesium (Mg), aluminum (Al), aluminum-lithium (Al—Li), calcium (Ca), magnesium-indium (Mg—In), and magnesium-silver (Mg—Ag). In some embodiments, ITO or IZO may be used in a top-emission light-emitting device.

According to embodiments of the present invention, an organic light-emitting device may have any structure depending on a requirement, not limited to the structure of the organic light-emitting device 100 of FIG. 4. For example, the HIL 120 may be omitted.

In an embodiment, an organic light-emitting device including the carbon thin film may have a structure of a first electrode (for example, a carbon thin film as described above)/HTL (NPB, 20 nm)/EML (BeBq2:C545T, 20 nm)/ETL (BeBq2, 20 nm)/EIL (LiF, 1 nm)/second electrode (Al, 130 nm), but is not limited thereto.

The first electrode of the organic light-emitting device manufactured using the carbon thin film preparation method described above may have satisfactory electrical characteristics, and thus may have reduced manufacturing costs.

FIG. 5 is a schematic view of an OPV 200 including a carbon thin film described above, according to an embodiment of the present invention.

Referring to FIG. 5, the OPV 200 may include a first electrode 210, a buffer layer 220, a heterojunction layer 230, an electron acceptor layer 240, and a second electrode 250. Light incident on the OPV 200 may be split into holes and electrons in the heterojunction layer 230, the electrons migrate to the second electrode 150 through the electron acceptor layer 240, and the holes migrate to the first electrode 210 through the buffer layer 220.

The first electrode 210 may be a carbon thin film formed by any of the methods described above.

The buffer layer 220 may be formed using a material that is able to accept holes. In some embodiments the buffer layer 220 may be formed using a material for forming the HIL 120 or HTL 130 described above.

The heterojunction layer 230 may include a material that is able to split incident light into holes and electrons. For example, the heterojunction layer 230 may include a p-type semiconductor material and an n-type organic semiconductor material. For example, the heterojunction layer 230 may include poly(3-hexylthiophene) and phenyl-c61-butyric acid methyl ester (BM), but is not limited thereto.

The electron acceptor layer 240 may be formed using a material that is able to accept electrons. For example, the electron acceptor layer 240 may be formed using a material for forming the EIL 160 of the OLED 100 described above.

The second electrode 250 may act as a cathode (electron injection electrode), and may be formed using a metal having a relatively low work function, an alloy having a relatively low work function, an electrically conductive compound having a relatively low work function, and any mixtures thereof. Non-limiting examples of these materials include lithium (Li), magnesium (Mg), aluminum (Al), aluminum-lithium (Al—Li), calcium (Ca), magnesium-indium (Mg—In), and magnesium-silver (Mg—Ag).

In an embodiment, an OPV including a carbon thin film formed by any of the methods described above? may have a structure of a first electrode (for example, the carbon thin film described above)/buffer layer (PEDOT, 35 nm)/heterojunction layer (P3HT:PCBM, 210 nm)/electron acceptor layer (BaF₂, 1 nm)/second electrode (Al, 100 nm), but is not limited thereto.

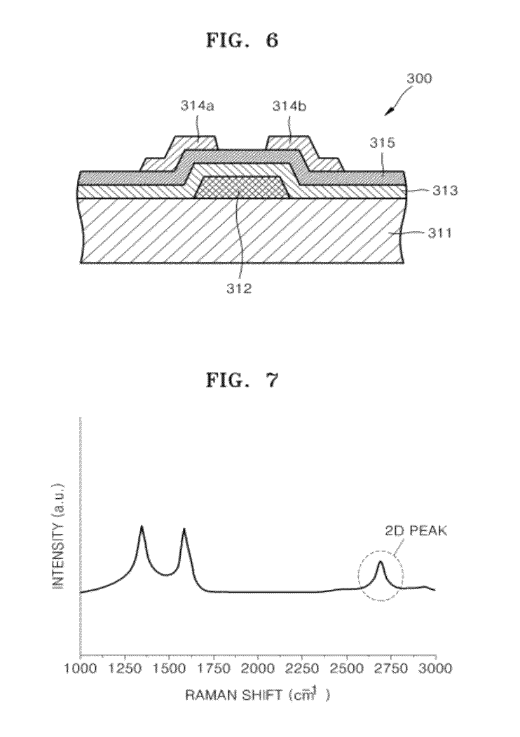

FIG. 6 is a schematic view of an organic thin film transistor (OTFT) 300 including a carbon thin film described above, according to an embodiment of the present invention.

Referring to FIG. 6, the OTFT 300 may include a substrate 311, a gate electrode 312, an insulating layer 313, an organic semiconductor layer 315, a source electrode 314a, and a drain electrode 314b. At least one of the gate electrode 312, the organic semiconductor layer 315, the source electrode 314a, and the drain electrode 314b may be a carbon thin film formed by any of the methods described above.

The substrate 311 may be any substrate that is used in common electronic devices. In this regard, the substrate 311 may be a glass substrate or a plastic substrate, depending on required transparency, surface smoothness, ease of handling, and water resistance.

The gate electrode 312 is formed in a predetermined pattern on the substrate 311. The gate electrode 312 may be formed using a metal or a metal alloy such as Au, Ag, Cu, Ni, Pt, Pd, Al, Mo, Al:Nd, or Mo:W, but is not limited thereto. The gate electrode 312 may be formed using a carbon thin film described above.

The insulating layer 313 is disposed on the gate electrode 312 to cover the gate electrode 312. The insulating layer 313 may be formed using an inorganic material such as a metal oxide or a metal nitride, or any of a variety of materials, including an organic material such as an insulating organic polymer.

The organic semiconductor layer 315 may be disposed on the insulating layer 313. The organic semiconductor layer 315 may be a carbon thin film described above. The organic semiconductor layer 315 may include a material selected from among pentacene, tetracene, anthracene, naphthalene, α-6-thiophene, α-4-thiophene, perylene and its derivative, rubrene and its derivative, coronene and its derivative, perylenetetracarboxylic diimide and its derivative, perylenetetracarboxylic dianhydride and its derivative, polythiophene and its derivative, polyparaphenylenevinylene and its derivative, polyparaphenylene and its derivative, polyfluorene and its derivative, polythiophene vinylene and its derivative, a polythiophene-heterocyclic aromatic copolymer and its derivative, oligoacene of naphthalene and its derivative, oligothiophene of α-5-thiophene and its derivative, metal-containing or non-metal-containing phthalocyanine and its derivative, pyromellitic dianhydride and its derivative, and pyromellitic diimide and its derivative, but is not limited thereto.

The source electrode 314a and the drain electrode 314b are disposed separated on the organic semiconductor layer 315. The source electrode 314a and the drain electrode 314b may be disposed to partially overlap with the gate electrode 312, as illustrated in FIG. 6, but are not limited thereto. The source electrode 314a and the drain electrode 314b may each be formed using a carbon thin film as described above. In some embodiments the source electrode 314a and the drain electrode 314b may be formed of a noble metal having a work function of 5.0 eV or greater, for example, selected from among Au, Pd, Pt, Ni, Rh, Ru, Ir, Os, and a combination thereof, taking into account the work function of a material of the organic semiconductor layer 315.

In an embodiment an OTFT may have a structure of substrate/gate electrode/insulating layer/organic semiconductor layer (such a carbon thin film as described above)/source and drain electrodes (Au, 10 nm). In another embodiment an OTFT may have a structure of substrate/gate electrode/insulating layer/organic semiconductor layer (pentacene)/source and drain electrodes (such a carbon thin film as described above).

Although electronic devices to which a carbon thin film as described above is applicable are described with reference to FIGS. 4 to 6, the present invention is not limited thereto. For example, in the OLED 100 of FIG. 4 the second electrode 170, instead of the first electrode 110, may be formed of the carbon thin film depending on the material of the first electrode 110. Although FIG. 6 illustrates a bottom-gate type OTFT, a carbon thin film according to any of the embodiments of the present invention may be applicable to any of a variety of structures of OTFTs, such as a top-gate type OTFT.

According to embodiments of the present invention, the carbon thin film described above may be applicable as an electrode or active material not only in the above-described devices, but also in other electronic devices, including a memory, an electrochemical/bio sensor, an RF device, a rectifier, and a complementary metal oxide semiconductor (CMOS) device, and in electrochemical devices such as a lithium battery and a fuel cell, but is not limited thereto.

One or more embodiments of the present invention will now be described in detail with reference to the following examples. However, these examples are not intended to limit the scope of the one or more embodiments of the present invention.

### EXAMPLES

### Example 1

### Carbon Thin Film Using Coal Tar

Preparation of Coal Tar

As a byproduct from a chemical plant at a Gwangyang mill of POSCO, a Korean steelmaker, crude coal tar was provided, followed by removing moisture and fine particles (coal powder and furnace refractory fine particles) using a screw decanter by centrifugation, and dissolving the centrifuged product in a quinoline solvent, thereby preparing coal tar.

Formation of Coal Tar Layer

A mixture of the coal tar and toluene (about 1 wt % of coal tar) was prepared and filtered through a 0.45 μm-syringe filter, and then spin-coated on a substrate (a silicon substrate (2.0 cm×2.0 cm) with a 300 nm-thick silicon oxide layer thereon). Afterward, the coated substrate was baked at about 100° C. for about 20 minutes to remove the toluene solvent, thereby forming a 100 nm-thick coal tar layer as a precursor film.

Formation of Carbon Thin Film and Resistivity Measurement Thereof

After sputtering Ni on the coal tar layer using Ni to form a Ni protective film having a thickness of about 50 nm, the resulting substrate was placed in a quartz tube and then equipped in a furnace. While argon (Ar) gas and hydrogen gas were supplied at about 50 sccm and about 10 sccm, respectively, into the quartz tube at 4.0 Torr or less, the substrate was thermally treated using a halogen-lamp heat source at about 1000° C. for 1 minute. After completion of the thermal treatment, the quartz tube with the substrate was removed from the furnace and naturally cooled. More than part of the Ni protective film remaining on the carbon thin film was removed using a 1M aqueous FeCl₃ solution as an etchant, thereby yielding the carbon thin film (size: 2.0 cm×2.0 cm, and thickness: about 20 nm). Surface resistivity of the carbon thin film was measured using a 4-point probe. As a result, the carbon thin film was found to have a surface resistivity of about 300 Ω/□.

### Example 2

### Carbon Thin Film Using Coal Tar Pitch

Preparation of Coal Tar Pitch

A coal tar pitch was prepared in the same manner as in the preparation of preparing the coal tar in Example 1, except that crude coal tar pitch (softening point: 110° C., a byproduct from a Gwangyang mill of POSCO) as a residue from coal tar distillation was used instead of the crude coal tar.

Formation of Coal Tar Pitch Layer

A coal tar pitch layer having a thickness of about 4 nm was prepared as a precursor film in the same manner as in the formation of the coal tar layer in Example 1, except that the coal tar pitch prepared as described above and quinoline were used instead of coal tar and toluene.

Formation of Carbon Thin Film and Resistivity Measurement Thereof

A carbon thin film was formed in the same manner as in the formation of the carbon thin film in Example 1, except that the coal tar pitch layer formed as described above was used instead of the coal tar layer. Surface resistivity of the carbon thin film was measured using a 4-point probe. As a result, the carbon thin film was found to have a surface resistivity of about 500 Ω/□.

### Example 3

### Formation of Graphene Using Coal Tar Pitch

A silicon substrate (5.0 cm×5.0 cm) with a 300-nm thick silicon oxide layer was prepared. After sputtering Cu on the silicon oxide layer using Cu as a sputter target to form a Cu catalyst layer having a thickness of about 500 nm, a mixture (about 1 wt % of coal tar pitch) of coal tar pitch (softening point: 150° C., a byproduct from a Gwangyang mill of POSCO) and quinoline as a solvent was spin-coated on the Cu catalyst film, and the resulting product was baked at about 100° C. for about 10 minutes to form a coal tar pitch layer having a thickness of about 100 nm as a precursor film. Afterward, the substrate was placed in a 1-inch quartz tube and then equipped in a furnace. The furnace was maintained at a vacuum level of about 100 mTorr at about 1000° C., the vacuum level of the furnace was then dropped to and maintained at about 30 Torr or less with a supply of hydrogen gas (at about 50 sccm) and argon gas (at about 500 sccm), and the coal tar layer was thermally degraded for about 15 minutes. While Ar gas was constantly supplied into the quartz tube at about 50 sccm, the substrate was thermally treated at about 1000° C. for about 1 minute using a halogen-lamp heat source, so that the coal tart pitch layer was converted into graphene. After completion of the thermal treatment, the heat source of the furnace was removed away from the sample, which was then naturally cooled with the supply of hydrogen gas and argon gas. Afterward, the substrate was removed from the furnace, a poly(methylmethacrylate)(PMMA) solution was coated on graphene at about 3000 rpm for 1 min, and the Cu catalyst film underlying the graphene was removed for about 2 hours using a Marble's reagent (CuₛO4:HCl:H₂O=10 g:50 mL:50 mL) as an etchant. A resulting PMMA/graphene film was washed with water three times for about 10 minutes to remove etchant ions, and then dried at about 70° C. in a vacuum for about 2 hours to move the remaining water. After the PMMA/graphene film was so disposed that the graphene contacted a surface of the PET substrate, the PMMA of the PMMA/graphene film was washed twice with acetone to be removed, thereby transferring the graphene of the PMMA/graphene film to the PET substrate. The graphene on the PET substrate was dried by a flow of nitrogen gas, and surface resistivity of the graphene film was measured using a 4-point probe. As a result, the graphene film was found to have a surface resistivity of about 550 Ω/□.

### Example 4

### Manufacture of Green Light-Emitting OLED Using Graphene Electrode

Four layers-graphene were formed on the PET substrate by transferring graphene four times to the PET substrate using the method described in Example 3. After the four layers-graphene (anode) were patterned using RIE, a 20-nm thick NPB hole transport layer, a 20-nm thick Bebq₂:C545T (1.5 wt % of C545T) emission layer, a 20-nm thick Bebq₂ electron transport layer, a 1-nm thick Liq electron transport layer, and a 130-nm thick Al cathode were sequentially formed thereon (using vacuum vapor deposition), thereby manufacturing an OLED (having an emission area of 2×3 mm²). Emission efficiency of the OLED was measured using a Keithley 236 source measurement unit and a Minolta CS 2000 Spectrometer and was found to be about 30 cd/A.

### Evaluation Example

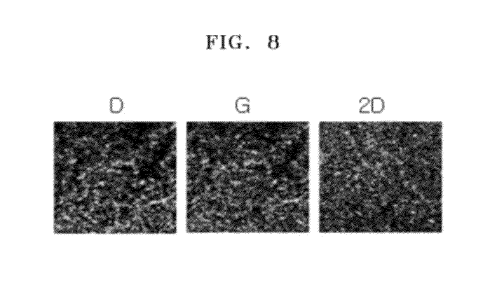

Raman spectrum and Raman mapping images were evaluated on the carbon thin film of Example 1 using a WITEC Confocal Raman Spectroscopy System. The results are shown in FIGS. 7 and 8. The Raman spectrum was measured using a 50× objective lens at room temperature and a laser wavelength of about 532 nm.

Referring to FIG. 7, the Raman spectrum of the carbon thin film of Example 1 includes a 2D peak near about 2705 cm⁻¹, indicating that the carbon thin film of Example 1 is a graphene sheet. A ratio (I_{G}/I_{D}) of G peak intensity (I_{G}) near 1580 cm⁻¹ to 2D peak intensity (I_{2D}) near 2705 cm⁻¹ was about 1.825.

By using the method of manufacturing a carbon thin film, a large-area, 2-dimensional carbon thin film may be easily manufactured in a stable, safe, and economical way. Using coal tar and coal tar pitch that are byproducts in the steel and petrochemical industries, the carbon thin film preparation method is environmentally friendly in view of recycling of resource. A carbon thin film prepared to grow on a substrate by using this method may allow formation of a device directly on the carbon thin film without having to transfer it to another substrate, which is conducive to simplifying device manufacturing processes. The carbon thin film preparation method may form a carbon thin film having high conductivity, which may be applicable to various types of electrodes or wirings that need to be conductive.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a carbon thin film, the method comprising:
forming a precursor film that includes at least one of coal tar and coal tar pitch on a substrate;
forming at least one of a catalyst film between the substrate and the precursor film, and a protective film on the precursor film; and
thermally treating the substrate to form a carbon thin film thereon.

2. The method of claim 1, wherein the method comprises forming the protective film on the precursor film, and the forming of the protective film on the precursor film is performed after the formation of the precursor film.

3. The method of claim 1, wherein the method comprises forming the catalyst film between the substrate and the precursor film, and the forming of the catalyst film on the substrate is performed before the formation of the precursor film.

4. The method of claim 1, wherein the method comprises forming the protective film on the precursor film and forming the catalyst film between the substrate and the precursor film, and the forming of the catalyst film on the substrate is performed before the formation of the precursor film, and the forming of the protective film on the precursor film is performed after the formation of the precursor film.

5. The method of claim 1, wherein the substrate comprises silicon, silicon oxide, silicon nitride, metal foil, metal oxide, highly ordered pyrolytic graphite (HOPG), hexagonal boron nitride (h-BN), a c-plane sapphire wafer, zinc sulfide (ZnS), a polymer substrate, or a combination of at least two of these materials.

6. The method of claim 1, wherein the protective film comprises at least one material of a metal, an inorganic oxide, and an inorganic nitride.

7. The method of claim 1, wherein the protective film comprises copper (Cu), nickel (Ni), palladium (Pd), gold (Au), silver (Ag), aluminum (Al), molybdenum (Mo), copper oxide, nickel oxide, palladium oxide, aluminum oxide, molybdenum oxide, silicon oxide, germanium oxide, silicon nitride, boron nitride, lithium nitride (Li₃N), copper nitride (Cu₃N), Mg₃N₂, Be₃N₂, Ca₃N₂, Sr₃N₂, Ba₃N₂. or a combination of at least two of these materials.

8. The method of claim 1, wherein the protective film has a thickness from about 2 nm to about 2000 nm.

9. The method of claim 1, wherein the catalyst film comprises nickel (Ni), cobalt (Co), iron (Fe), gold (Au), palladium (Pd), aluminum (Al), chromium (Cr), copper (Cu), magnesium (Mg), molybdenum (Mo), rhodium (Rh), silicon (Si), tantalum (Ta), titanium (Ti), tungsten (W), uranium (Ur), vanadium (V), zirconium (Zr), or a combination of at least two of these materials.

10. The method of claim 1, wherein the catalyst film has a thickness from about 100 nm to about 1000 nm.

11. The method of claim 1, wherein the thermal treatment is performed under the condition where at least one of the coal tar and the coal tar pitch in the precursor film is carbonized.

12. The method of claim 1, wherein the thermal treatment is performed in an inert atmosphere or in a vacuum at a temperature from a temperature higher than or equal to thermal degradation temperature of at least one of the coal tar and the coal tar pitch in the precursor film to about 2000° C. or less for a duration from about 1 second to about 5 days.

13. The method of claim 2, wherein at least part of the protective film remains on the carbon thin film after the forming of the carbon thin film on the substrate, and the method further comprises removing the protective film remaining on the carbon thin film.

14. The method of claim 4, wherein at least part of the protective film remains on the carbon thin film after the forming of the carbon thin film on the substrate, and the method further comprises removing the protective film remaining on the carbon thin film.

15. The method of claim 1, further comprising at least one of patterning the precursor film and at least one of the catalyst film and the protective film in a predetermined pattern before the thermal treatment, and patterning the carbon thin film in a predetermined pattern after the thermal treatment.

16. The method of claim 1, wherein the carbon thin film is selected from the group consisting of a graphite sheet, a graphene sheet, and an amorphous carbon sheet.

17. An electronic device comprising a carbon thin film prepared by the method of claim 1.

18. The electronic device of claim 17, wherein the electronic device is an inorganic light-emitting diode, an organic light-emitting diode, an inorganic solar cell, an organic photovoltaic diode (OPV), an inorganic thin film transistor, a memory, an electrochemical/bio sensor, an RF device, a rectifier, a complementary metal oxide semiconductor (CMOS) device, or an organic thin film transistor (OTFT).

19. An electrochemical device comprising a carbon thin film prepared by the method of claim 1.

20. The electrochemical device of claim 19, wherein the electrochemical device is a lithium battery or a fuel cell.
